(19) United States
(12) Patent Application Publication
(10) Pub. No.: US 2002/0129006 A1
(43) Pub. Date: Sep. 12, 2002

(54) System and method for modifying a document format

(76) Inventors: David Emmett, Palo Alto, CA (US); Ahmad Rahman, San Jose, CA (US)

Correspondence Address: Skjerven Morrill MacPherson LLP, 28th Floor, Three Embarcadero Ctr., San Francisoc, CA, 94111, US

(21) Appl. No.: 10/076,786

(22) Filed: Feb. 14, 2002

Related U.S. Application Data
(60) Provisional application No. 60/269,498, filed on Feb. 16, 2001.
(60) Provisional application No. 60/284,354, filed on Apr. 16, 2001.

(51) Int. Cl. G06F 7/00

(52) U.S. Cl. 707/1

(57) ABSTRACT

A system and method are disclosed for modifying a document format. In one embodiment, a structure of a first document is extracted to form a first data structure. The first data structure is then modified to form a second data structure. Content from a second document is extracted from the second document and inserted into the second data structure to permit display of the content of the second document in the format of the second data structure.

### CROSS REFERENCE TO RELATED APPLICATIONS

This application claims the benefit and priority of U.S. Provisional Patent Application No. 60/269,498 entitled “Navigation Control Module” filed Feb. 16, 2001 and of U.S. Provisional Patent Application No. 60/284,354 entitled “Enhanced Navigation Control Module (ENCM)” filed Apr. 16, 2001, the disclosures of which are hereby incorporated by reference in their respective entireties.

### CROSS REFERENCE TO ATTACHED COMPACT DISK APPENDIX

A Compact Disk Appendix, of which two identical copies are attached hereto forms a part of the present disclosure and is incorporated herein by reference in its entirety. The Compact Disk Appendix contains the following files: Automa˜1.cpp, 41 KB, 02/13/2002; Automa˜1.h, 2 KB, 02/13/2002; Classify.cpp, 15 KB, 02/13/2002; Classify.h, 1 KB, 02/13/2002; Handle˜1.cpp, 25 KB, 02/13/2002; Handle˜1.h, 4 KB, 02/13/2002; Ncmmgr.cpp, 8 KB, 02/13/2002; Ncmmgr.h, 1 KB, 02/13/2002; Url.cpp, 2 KB, 02/13/2002; and Url.h, 1 KB, 02/13/2002.

### RESERVATION OF COPYRIGHT

A claim of copyright protection is made on portions of the description in this patent document, including the contents of the Compact Disk Appendix. The copyright owner has no objection to the facsimile reproduction by anyone of the patent document or the patent disclosure, exactly as it appears in the Patent and Trademark Office patent file or records, but reserves all other rights whatsoever.

### TECHNICAL FIELD

The present invention relates to a system and method for modifying a document format.

### BACKGROUND

Handheld devices, including Personal Digital Assistants (PDAs) and cellular telephones, offer connectivity to the Internet and permit access to documents available over the Internet. Wireless Application Protocol (WAP) is a standard for providing cellular phones, PDAs, pagers and other handheld devices with secure access to web pages. WAP features the Wireless Markup Language (WML), which generally serves as a universal medium for translating web-based HTML content into a format that accommodates small form factor displays and key sets found on conventional handheld devices. WML also allows handheld device manufacturers to include microbrowsers in their products that accept WML input from a WAP-based system across vast regions of the world.

A packet-based service called “i-Mode” provides information service for mobile telephones and permits users of mobile telephones to browse web content via a mobile telephone. In recent years, the number of users of the i-Mode standard has increased dramatically, perhaps most significantly in the United States and Japan.

The proliferation of wireless PDAs has also created a popular means for handheld Internet access. However, presenting IP-based content, and other content developed for display on large form factor devices (e.g., PC monitors), on small form factor screens of handheld devices has, in the past, been problematic. Two primary methods of presenting such content to handheld devices have been employed.

The first such method can be termed “fixed mapping.” Fixed mapping typically involves rewriting an existing document, such as an HTML-based web page, to conform to a specific standard, such as WAP or i-Mode. A web server must then maintain the rewritten web site as a separate site with its own URL in addition to the original document. As new content is added to the original document, a web site operator must manually trim, edit, and condense the new content by rewriting the new content into a format that will accommodate the interface parameters of handheld devices. This method is limited in that considerable time and expense are typically required to maintain the two web sites in parallel. Further, the manual editing of the rewritten web site can be time-consuming, burdensome, and expensive.

The second method may be termed “transcoding.” Transcoding typically involves the use of software that takes the entire content of a web site as input, converts the entire content into a format of a specific handheld wireless standard for transmission to handheld devices. The entire content, as formatted according to a handheld wireless standard, is then transmitted to the handheld device. This conversion may be performed “on-the-fly” (i.e., automatically in real time) or may be performed manually.

Transcoding has the advantage of reducing the investment to reach wireless markets since it leverages existing web sites. From a user standpoint, transcoding is desirable in that it preserves all the text-based information from the originating site. For large volumes of text, however, using this approach may overwhelm the handheld device user with large volumes of text to be viewed on a small form factor display. Further, the unorganized transcoded content makes changes or modifications to the wirelessly enabled web site more difficult for the web site operator.

In addition, many wireless handheld devices have limited bandwidth. For example, today, many wireless handheld devices have data rates in the range of about 9.6-64 kbs. Thus, downloading an entire web page designed for viewing on a large form factor device at data rates common to handheld wireless devices may require large download times. These large download times may be burdensome to the user who must wait while the entire web page downloads, even though the user may only desire to view a portion of the web page. Further, these large download times may be expensive for users who pay for wireless service based on the amount of time or the number of packets downloaded. For example, some i-Mode services charges are packet-based so downloading large pages cost more to download than smaller pages if the larger pages result in more data packets being sent to the user.

Additional background details are disclosed in U.S. Pat. No. 6,336,124, the disclosure of which is hereby incorporated by reference.

### SUMMARY

Accordingly, a need exists to provide a system and method for presenting content developed for display on large form factor devices (e.g., PC monitors) on small form factor screens of handheld devices.

Pursuant to one embodiment of the present invention, a document having a first structure is divided into multiple blocks, or sub-documents. Content of the blocks is arranged in a list such that individual entries of the list include the content of associated blocks. A database is provided that includes a data structure associated with the document. The data structure stored in the database specifies a manner of displaying the list entries. Then, the entries of the list arc inserted into the data structure to form an output file formatted in accordance with the data structure. Portions of the output file may then be transmitted over a network, such as the Internet, to a client device. The client device may comprise a PDA, a mobile telephone, a pager, or the like. Thus, according to this embodiment, regardless of the specific contents of the document, which may change from time to time, the document is reformatted pursuant to the associated data structure stored in the database.

According to another aspect, the database entry associated with a document may include labels associated with one or more of the entries of the list. The database entry associated with the document may also specify that certain of the entries of the list not be displayed at all at the client device. Further, the database entry associated with the document may specify an order in which various entries of the list are displayed at the handheld device.

In one embodiment, the database comprises an element of an application server and may be configured remotely over a network, such as the Internet or an intranet. For example, a user at a client personal computer may access the application server over the network using a web browser. Specifically, the user may specify, for a particular document, such as a web page, the manner in which the document will be displayed at a client handheld device by adding, or modifying, an entry in the database associated with the document.

The contents of the database may be configured, or modified, by different means. For example, if the application server were hosted on a personal network, the owner, or system administrator, of the personal network could configure the contents of the database from any client computer coupled to the personal network, such as via the Internet or an intranet. Alternatively, if the application server were hosted by a corporation, the contents of the database may be configured by the owner, or system administrator for the document for which the database is being modified.

In this regard, pursuant to an example embodiment of the present invention, the application server provides the user at the client personal computer with visual representation of the document with identifiable tags or labels. These visual tags or labels are provided to facilitate user modification of the underlying tree data structure of the document as formatted for a large form factor display. The user then modifies the tree data structure by, for example, deleting entries, moving entries, and changing labels assigned to various nodes of the data structure to form a modified data structure. This modified data structure is then later used by the application server to reformat the associated document for display at a small form factor display of a client.

Pursuant to another aspect of the present invention, the application server generates an output file associated with the document that includes a table of contents (TOC) and a set of sub-documents associated with the document. The table of contents comprises a page including the labels assigned to the various blocks of the document and the sub-documents comprise the content of associated blocks. Accordingly, in operation, when a small form factor client device requests a document from the application server, the application server returns the table of contents page, rather than all of the content of the entire document itself. The table of contents page includes links associated with entries in the table of contents page. These links comprise the addresses of associated sub-documents to permit the user to request a sub-document by selecting the associated, or corresponding, link.

Additional details regarding the present system and method may be understood by reference to the following detailed description when read in conjunction with the accompanying drawings.

### BRIEF DESCRIPTION OF THE DRAWINGS

FIG. 1 is a block diagram of a document delivery system in accordance with one embodiment of the present invention.

FIG. 2 is a block diagram of the formatter of FIG.1 in accordance with one embodiment of the present invention.

FIG. 3 is a block diagram of the mapper of FIG. 2 in accordance with one embodiment of the present invention.

FIG. 4 illustrates a tree data structure in accordance with one embodiment of the present invention.

FIG. 5 is a block diagram of the control module of FIG. 2 in accordance with one embodiment of the present invention.

FIG. 6 is a flowchart illustrating a method in accordance with one embodiment of the present invention.

Common reference numerals are used throughout the drawings and detailed description to indicate like elements.

### DETAILED DESCRIPTION

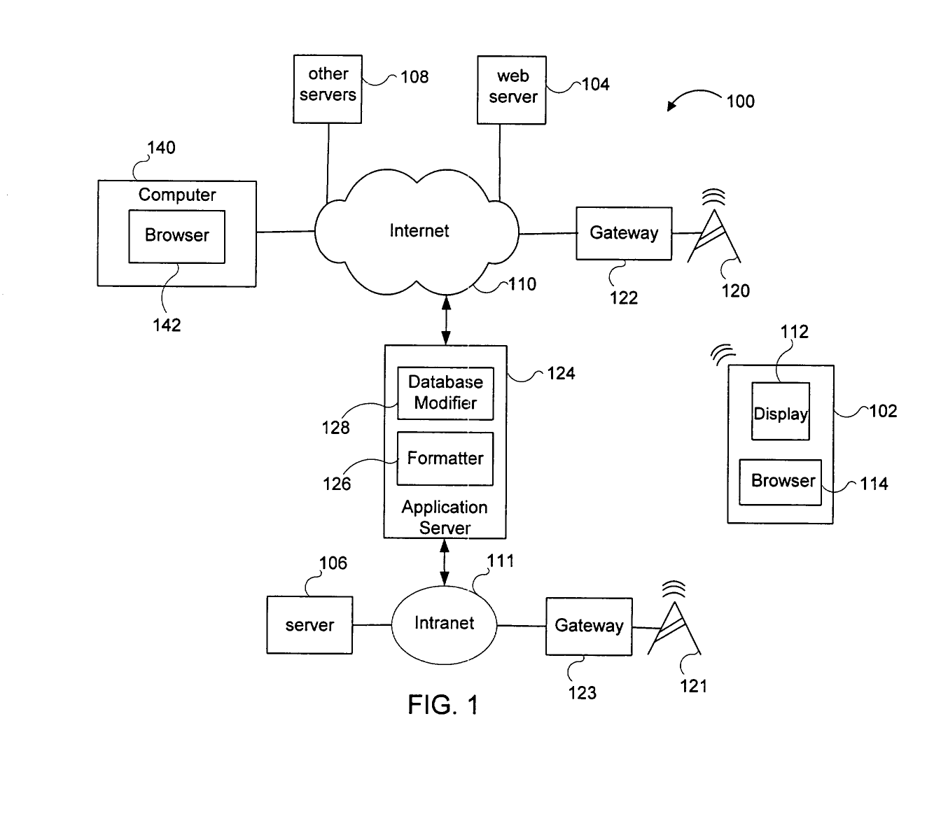

FIG.1 illustrates a document delivery system 100 in accordance with one embodiment of the present invention. The document delivery system 100 permits a client 102 to access content of documents (not shown) stored at server 104, server 106, or other servers 108 over a network 110, such as the Internet, and over a network 111, such as an intranet.

In one embodiment, the client 102 comprises a handheld device, such a PDA (Personal Digital Assistant), a mobile telephone, or the like, having a small form factor display 112. The client 102 also includes a web browser 114. The web browser 114 may comprise a microbrowser designed for small display screens on web-enabled cellular telephones, PDAs and other handheld devices, including wireless handheld devices.

The client 102 may exchange data with the network 110 in a wireless fashion via a wireless station 120 and a gateway 122 in accordance with WAP (Wireless Application Protocol), i-Mode, or other suitable protocol or service. Optionally, the client 102 may exchange data with the network 110 via a wired connection (not shown).

The client 102 may also exchange data with the network 111 in a wireless fashion via a wireless station 121 and a gateway 123 in accordance with WAP (Wireless Application Protocol), i-Mode, or other suitable protocol or service. Optionally, the client 102 may exchange data with the network 111 via a wired connection (not shown).

In one embodiment, the gateways 122, 123 are network devices that connect a wireless network with a wired network, such as the networks 110, 111. Access between the client 102 and application server 124 may also pass through one or more other firewalls (not shown), other gateway devices (not shown), or the like.

Pursuant to one embodiment, the client 102 transmits requests for documents stored on one or more of the servers 104, 106, 108 to the application server 124. The request for content may comprise an HTTP request or other suitable type of request. Moreover, the application server 124 may alternatively receive the request for a document from the client 102 from any network (e.g., 110, 111). The application server 124, among other functionality, functions as a proxy server and receives requests for documents from client devices, such as the client 102, over the networks 110, 111 and provides associated content in response to such requests by transmitting the associated content over at least one of the networks 110, 111.

In response to a request for a document from the client 102, the application server 124 requests the document identified by the request from one or more of the servers 104, 106, 108. Upon receipt of the document identified by the request, the application server 124 modifies the format of the document identified by the request for content using a formatter 126.

In one embodiment, the document identified by the request is an HTML or XML web page, although other document types, such as PDF (Portable Document Format), may also be requested. The application server 124 then transmits at least a portion of the reformatted content of the document identified by the request to the client 102 in a format compatible with the browser 114 for display at the display 112 of the client 102.

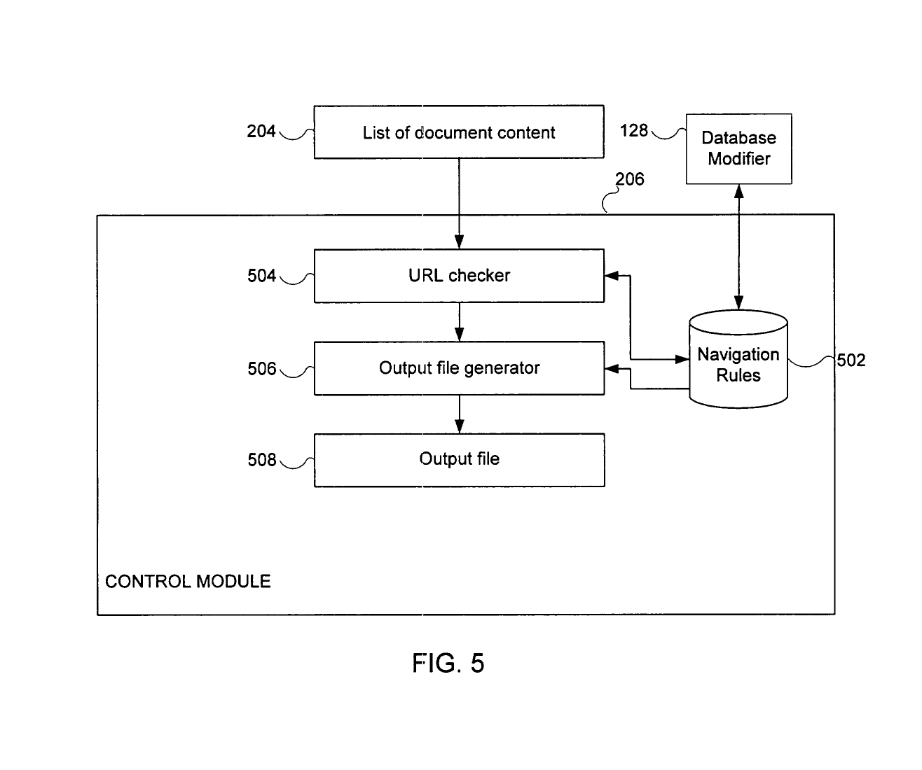

The formatter 126 includes a database (see, FIG. 5) that may be configured from a client admin computer 140 via a database modifier 128. The database modifier 128 may comprise a JavaScript module that penn its a user at the client admin computer to visually modify a data structure of a document into a desired format. The modification may be performed by, for example, adding labels, re-ordering, moving, deleting, or otherwise changing portions of the data structure and stores the changed, or modified version of the data structure in the database.

In particular, the client admin computer 140 includes a web browser 142, Such as Internet Explorer™ by Microsoft Corporation or other suitable web browser for permitting a user at the client admin computer 140 to view pages at a the database modifier 128 hosted at the application server 124. The pages at the database modifier 128 of the application server 124 permit user configuration of the FIG. 5 database, as discussed in more detail below.

In general, the formatter 126 receives the document identified by the request from one of the servers 104, 106, 108, divides the document into multiple blocks, and assigns labels to individual blocks. The formatter 126 then generates a list containing the content of the various blocks. The formatter 126 then uses a data structure associated with the document and stored at the application server 124 to generate an output file using the generated list of content. The output file may contain a Table of Contents (TOC) page and sub-documents. The TOC page lists labels associated with the sub-documents and may contain links to the sub-documents. The formatter 126 then transmits the TOC page, a headline, an image, or other content specified by a database at the application server 124 to the client 102 over at least one of the networks 110, 111. Details of the operation of the formatter 126 are discussed in more detail below.

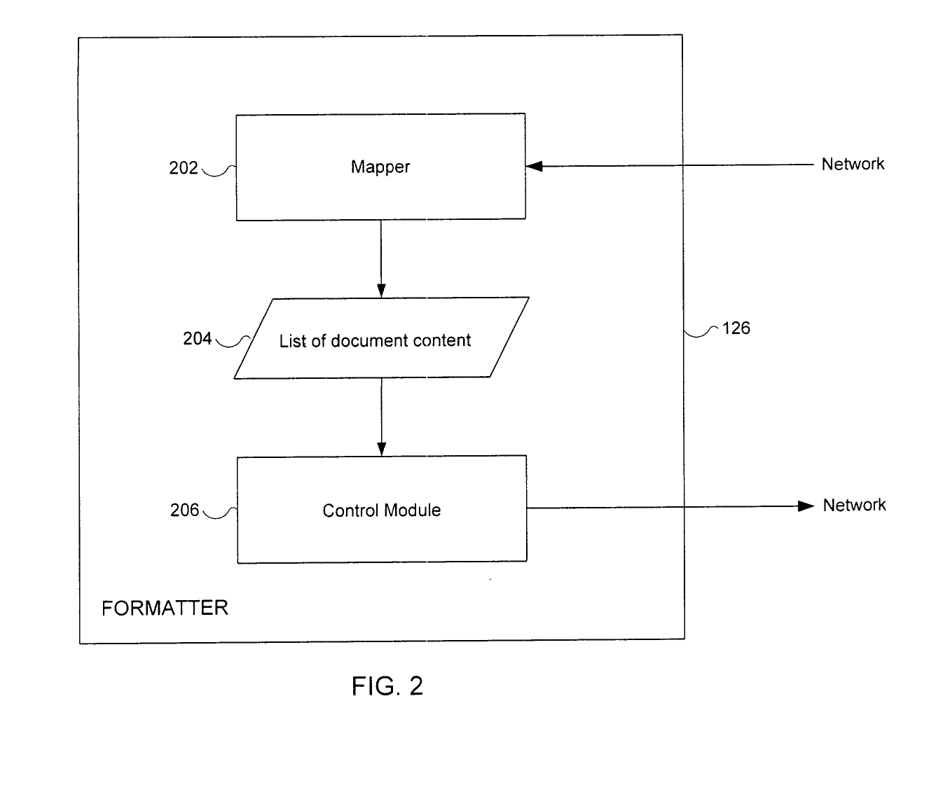

FIG. 2 illustrates details of the formatter 126 of FIG.1 according to one embodiment of the invention. As shown, the formatter 126 includes a mapper 202, and a control module 206, which may comprise software written in C++ or other suitable programming language. The mapper 202 receives the requested document and reformats the document as a list of document content 204. The control module 206 then generates an output file using the list document content 204. Additional details regarding the mapper 202, the list of document content 204, and the control module 206 are discussed below.

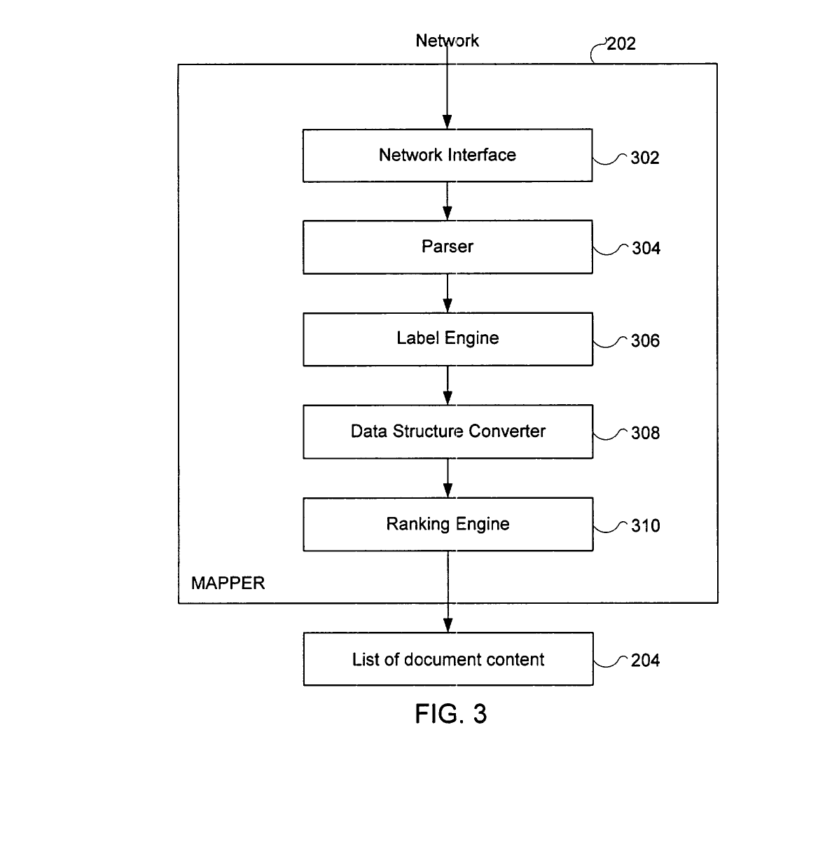

FIG. 3 illustrates details of the mapper 202 of FIG. 2 according to one embodiment of the invention. The mapper 202 includes a number of software modules stored in a computer readable medium. In particular, the mapper 202 includes a network interface 302, a parser 304, a label engine 306, a data structure converter 308, and a ranking engine 310. The network interface 302 receives the document requested from the network. As mentioned above, the document requested may comprise a web page, such as an HTML document, and XML document, or the like.

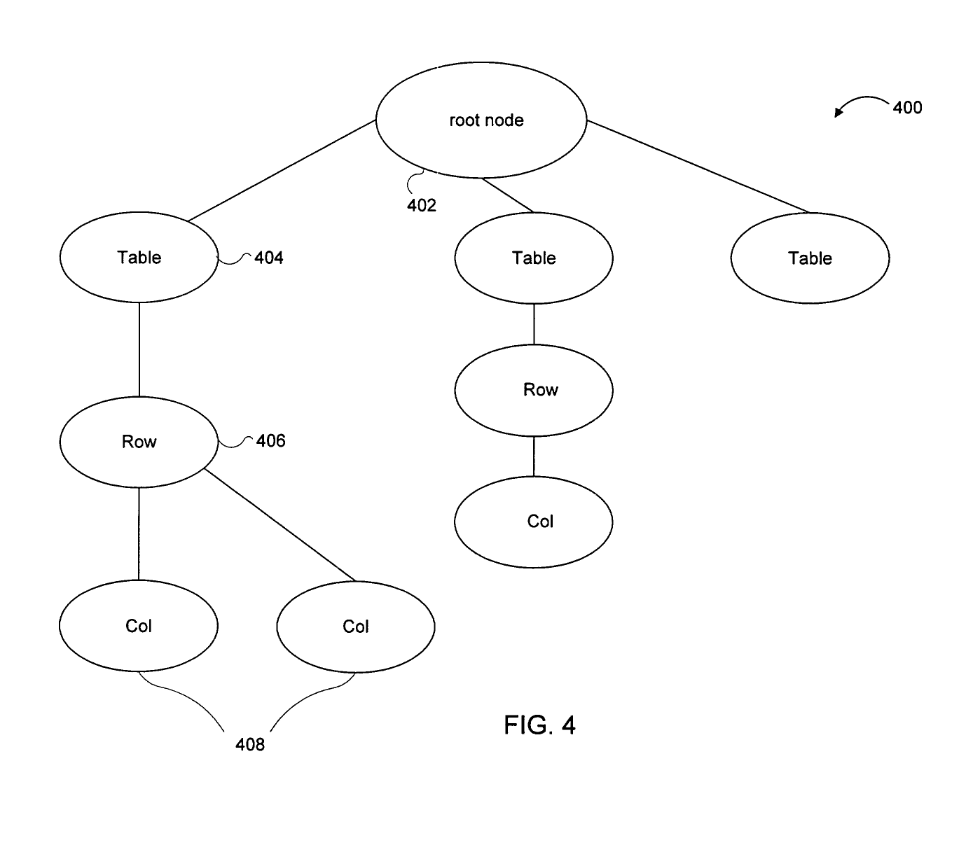

The parser 304 parses and decomposes the document into a tree data structure. FIG. 4 illustrates an example tree data structure 400, which may comprise a structural representation of a document, such as an HTML web page. As shown, the tree data structure 400 includes a root node 402 associated with the document. The parser 304 (FIG. 3) divides the document into multiple blocks and represents each block of the document as a table node 404 in the tree data structure 400. Each table node 404 has at least one row node 406 as a child node. Individual row nodes 406 each have at least one column node 408 as a child node. The column nodes 408 may then have additional table nodes as children. At this point, the tree data structure 400 may be recursive.

Thus, the document is divided into blocks, which may be defined by the structure of the document. The primary content for each of the blocks, or tables, is stored in the column nodes 408 and the remaining structure of the various blocks is represented in the other portions of the tree data structure 400.

Referring again to FIG. 3, the label engine 306 then assigns labels to individual blocks and may assign a classification to each block according to the contents of the block. In one embodiment, the label engine 306 assigns a classification to each block based on the block contents. For example, if the document is a web page, the web page may include links, text, forms, and pictures, as well as other classes of content.

The label engine 306 optionally analyzes individual blocks and assigns a classification to the block indicating the type, or class, of content in the block. Hence, a block that contains primarily links may be assigned a “navigation” classification, a block that contains primarily text may be assigned a “story” classification, a block that contains primarily pictures may be assigned an “image” classification, and a block that contains form information like an address may be assigned a “form” classification. The label engine 306 inserts a classifier associated with the assigned classification for each block into the table node of each block.

After classifying the blocks, the label engine 306 optionally merges, or combines, column nodes of each block that have the same classification. For example, if a given block has multiple column nodes having the classification of “story,” the label engine 306 would merge, or combine, the content of these column nodes. Likewise, if a given block has multiple columns having the classification of “navigation,” the label engine 306 would merge, or combine, the content of these column nodes.

In one embodiment, the label engine 306 may merge, or combine, column nodes in accordance with predetermined merging rules stored at the label engine 306. An example merging rule is that a large “story” node is not merged with another large “story” node. Another example merging rule is that a small “story” node may get merged with a “navigation” node. Thus, according to these rules, a large story, which is likely to be substantial enough to be viewed in isolation, will not be combined with another large story. However, a small story would not be isolated as a data packet associated with the small story may be able to contain additional information, such as one or more links. The specifics of these merging rules may vary and may be customized according to particular applications. The classifying and merging are optional according to some embodiments of the invention.

The label engine 306 also assigns a label to each block according to the block contents. In one embodiment, the label engine 306 uses the first several words of text of a block including text as the label for that block. In another embodiment, the label engine 306 assigns a label to a block based on the classification of the block. The label engine 306 then adds the assigned label to the table node of the associated block.

With continued reference to FIG. 3, a data structure converter 308 of the mapper 202 next “flattens” the tree data structure by converting the tree data structure into a linear, one-dimensional list containing the content of the column nodes 408. The table nodes 404 and the row nodes 406 are not included in the one-dimensional list. Individual entries in the one-dimensional list include the content of an associated column nodes 408.

A ranking engine 310 then ranks the entries in the one-dimensional list according to the content of the individual entries. In one embodiment, the ranking engine 310 analyzes characteristics of each entry and assigns a “weight” value to each entry. The weight assigned to each entry may be based on a variety of parameters, including, for example, the size of the font used in the entry, whether the text in the entry is boldface, the color of the text, whether the text is flashing, whether the text is underlined, and the position of the item in the document. Based on parameters such as these, the ranking engine 310 assigns a weight to individual entries in the one-dimensional list and then reorders the one-dimensional list according to the weighted rankings.

In one embodiment, the ranking engine 310 reorders the list in an order of decreasing weight values such that the first entry in the re-ordered list is the entry having the largest weight value and the last entry in the list the entry having the smallest weight value. The re-ordered list is then stored as the list of document content 204 (FIG. 2). Thus, in some embodiments, entries having large or bold text may be ranked before entries having smaller or plain text. Also, entries having a graphic may be ranked higher than entries having primarily links.

FIG. 5 illustrates details of the control module 206 of FIG. 2 in accordance with one embodiment of the present invention. In general, the control module 206 receives the list of document content 204 and creates a new document structure according a navigation rules database 502 and the list of document content 204.

The navigation rules database 502 contains a tree data structure for one or more documents. In one embodiment, contents of the navigation rules database 502 may be modified by accessing the formatter 126 (FIG. 1) from a client computer, such as the client admin computer 140 (FIG. 1). The database modifier 128 may modify the contents of the navigation rules database 502 described above.

In particular, the client admin computer 140 includes browser 142 and permits a user to access the database modifier 128 and to modify the contents of the navigation rules database 502. To modify the contents of the navigation rules database 502, a user at the client admin computer 140 directs the browser 142 to the database modifier 128. The database modifier 128 then presents the user with a GUI (Graphical User Interface) via the browser 142 that permits the user to view a default tree data structure, as constructed by the mapper 202, for a given document, such as an HTML or XML web page document. The default tree structure may be the structure of the document at issue as determined by parsing the document.

The user may then delete entries in the tree data structure. The user may alternatively move tree data structure entries from one location to another within the tree data structure. Further, the user may change the label or classification assigned to given nodes within the tree data structure. After the user has thus modified, or customized, the tree data structure, the control module 206 stores the modified tree data structure as an entry in the navigation rules database 502 associated with the document.

The control module 206 also includes a URL (Uniform Resource Locator) checker 504. The URL checker 504 receives the list of document content 204 from the mapper 302 and determines whether the navigation rules database 502 includes a tree data structure associated with the list of document content 204. In one embodiment, the URL checker determines whether the URL associated with the list of document content 204 matches a URL associated with an entry in the navigation rules database 502. If such a match exists, an output file generator 506 retrieves the tree data structure in the navigation rules database 502 associated with the list of document content 204. The output file generator 506 then creates an output file 508 based on the retrieved tree data structure using the content of list of document content 204.

The output file 508, in one embodiment, includes a table of contents (TOC) page that lists the labels of the document. The output file 508 also contains one or more sub-documents. Individual sub-pages are associated with individual entries in the TOC. One or more of the labels, or entries, of the TOC may include links to associated sub-documents.

If the URL checker 504 determines that the navigation rules database 502 does not include a tree data structure associated with the list of document content 204, then the output file generator 506 generates an output file 508 that includes a TOC page that lists the labels of the document. One or more of the labels, or entries, of the TOC may include links to associated sub-documents.

The formatter 126 then transmits the TOC page over at least one of the networks 110, 111 to the client 102. Upon receipt of the TOC page at the client 102, the client 102 displays the TOC page at the display 112 of the client 102. The user may then select a link associated with one of the entries of the TOC, which requests an associated sub-document from the output file 508. In response to a request for a sub-document in the output file 508, the formatter transmits the requested sub-document to the client 102 over at least one of the networks 110, 111 for display at the display 112 of the client 102.

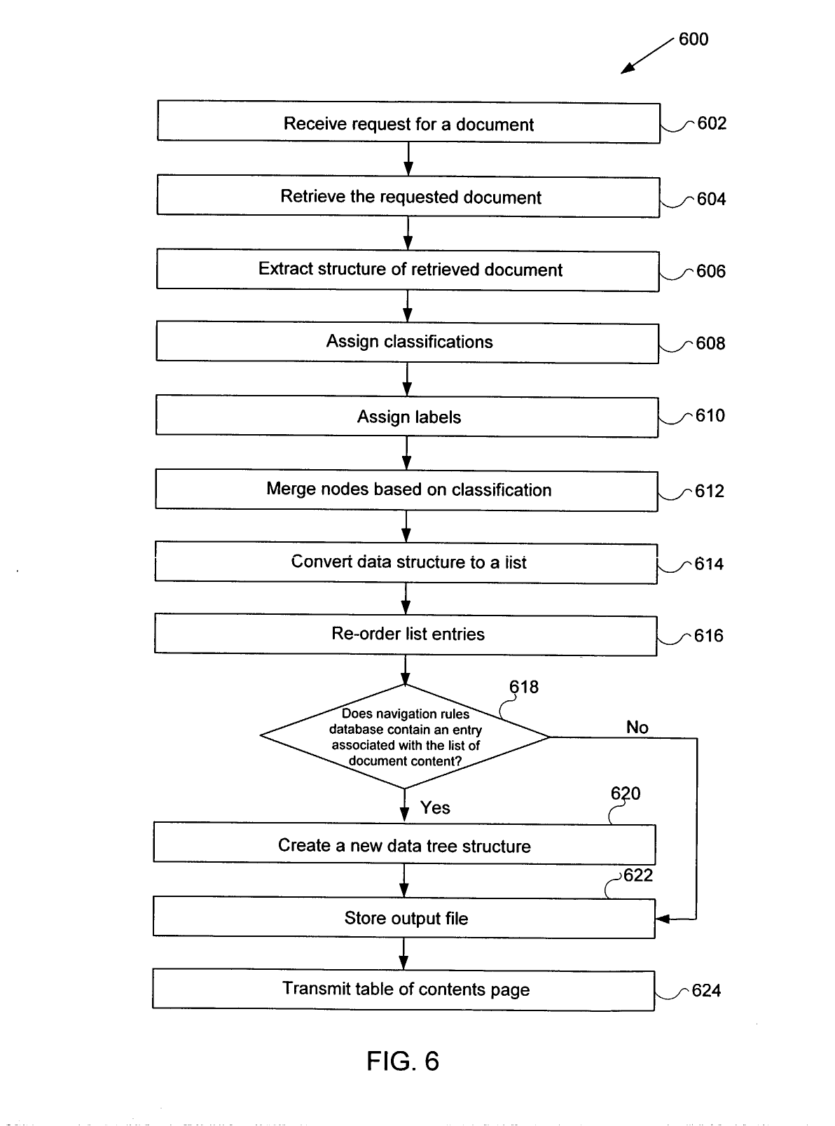

FIG. 6 illustrates a flowchart 600, which depicts a method according to one embodiment of the present invention. The method commences at block 602 where application server 124 receives a request for document from the client 102 (FIG. 1), the requested document residing on at least one of the servers 104, 106, 108. The request for document may be directed to the application server 124 directly. Alternatively, the request for document may be directed directly to one of the servers 104, 106, 108, which, in turn, redirects the request for document to the application server 124. The request for document may comprise an HTTP request or other suitable request. Moreover, the requested document may comprise a document in HTML, XML, PDF, or other suitable format.

Next, at block 604, the application server 124 retrieves the requested document from one or more of the servers 104, 106, 108 on which the document resides. This retrieval may be accomplished by the application server 124 transmitting an HTTP request to the server 104, 106, 108 at which the requested document is stored. For example, if the requested document resides at the server 104, the application server 124 requests the document from the server 104 over the network 110 and receives the requested document over the network 110.

Then, at block 606, the formatter 126 of the application server 124 extracts a structure of the retrieved document. In one embodiment, a parser 304 (FIG. 3) parses the retrieved document and generates a tree data structure representing the structure of the retrieved document. An example of such a tree data structure is illustrated in FIG. 4 and is described above.

For individual nodes of the tree data structure that include document content, the formatter 126 next analyzes the content of the nodes and assigns one of a set of predefined classifiers to each of the nodes based on the content of the nodes, pursuant to block 608. As discussed above, for a node having content comprising primarily text, the label engine 306 of the formatter 126 may assign a “story” classifier to the node. The classifier may comprise a text string or other identifier added to the node.

At block 610, the label engine 306 of the formatter 126 assigns labels to individual nodes of the tree data structure that include document content. The label engine 306 may assign a label based on the content of the node, the assigned classification of the node, or both. In one embodiment, the label engine 306 uses the first several words of nodes having text content as the label for the associated node. The label may indicate the content of the node being labeled.

At block 612, the label engine 306 merges nodes having content according to their classification. For example, if a pair of nodes having content both have the classification “navigation,” then the label engine 306 merges the content of these nodes to form a single node that includes the content of the merged nodes. Block 612 may alternatively be performed before block 610.

At block 614, the data structure converter 308 of the mapper 202 converts the tree data structure to a list. The data structure converter 308 extracts the nodes of the tree data structure that include content and generates a list comprising the nodes of the tree data structure that include content, without the other associated nodes, such as table and row nodes, which do not include content.

Next, at block 616, the ranking engine 310 (FIG. 3) of the mapper 202 reorders the entries of the list generated at block 614. In one embodiment, the ranking engine 310 assigns a weight value to each of the entries in the list according to certain parameters of the content of the entries, the classification of the list entry, or a combination thereof. Then, the ranking engine 310 reorders the list according to the weight value of the list entries. For example, the ranking engine 310 may order the list entries in order of decreasing weight value. The ranking engine 310 then stores the re-ordered list as the list of document content 204 (FIG. 2).

The control module 206 (FIG. 5) then determines whether the navigation rules database 520 includes an entry associated with the list of document content 204, pursuant to block 618. In one embodiment, the URL checker 504 of the control module 206 determines whether a URL associated with the list of document content 204 matches a URL associated with an entry in the navigation rules database 502. The URL checker 504 determines that the navigation rules database 502 contains an entry associated with the list of document content if such a match exists and execution proceeds to block 620, else execution proceeds to block 622.

At block 620, the output file generator 506 creates a new data tree structure according using the list of document content 204 and the associated entry of the navigation rules database 502. The entry of the navigation rules database 502 may specify labels to be assigned to the various nodes, the location of the various nodes within the new data tree structure, and whether certain nodes are included in the new data tree structure. The output file generator 506 then creates a new data tree structure according to the entry in the navigation rules database 502 and inserts the associated content from the list of document content 204 to form a new data tree, which may be stored as the output file 508.

At block 622, the output file generator 506 stores the new data tree structure as the output file 508 if the navigation rules database 502 contains as entry associated with the list of document content 204. Otherwise, the output file generator 506 stores the list of document content as the output file 508.

The output file 508 includes a table of contents (TOC) page that lists the labels of the nodes having content and sub-documents that include the content of blocks associated with the labels. Each of the sub-documents is associated with one of the links so that a user at the client 102 may request a sub-document by selecting the link associated therewith.

Lastly, pursuant to block 624, the formatter 126 transmits the TOC page to the client 102.

The above-described embodiments of the present invention are meant to be merely illustrative and not limiting. Thus, those skilled in the art will appreciate that various changes and modifications may be made without departing from this invention in its broader aspects. Therefore, the appended claims encompass such changes and modifications as fall within the scope of this invention.

What is claimed is:

1. A method for converting a document from a first format to a second format, the method comprising:
dividing a document having a first structure into blocks;
creating a list having entries, individual entries of the list containing content of associated ones of the blocks;
providing a database including a data structure associated with the document, the data structure specifying a manner of displaying at least one of the entries;
inserting entries of the list into the data structure to form an output file.

2. The method for converting a document from a first format to a second format according to claim 1, further comprising transmitting at least a portion of the output file over a network to a client device.

3. The method for converting a document from a first format to a second format according to claim 1 wherein the creating a list further comprises assigning a classification to individual list entries.

4. The method for converting a document from a first format to a second format according to claim 3, further comprising merging list entries having the same classification.

5. The method for converting a document from a first format to a second format according to claim 1 wherein the creating a list further comprises re-ordering the list according to the content of individual list entries.

6. The method for converting a document from a first format to a second format according to claim 1 wherein the output file contains sub-documents and a table of contents page listing the labels, wherein individual sub-documents are associated with individual labels.

7. The method for converting a document from a first format to a second format according to claim 1, further comprising:
extracting a structure of the document to form an extracted data structure associated with the document;
modifying the extracted data structure;
storing the modified extracted data structure as the data structure.

8. The method for converting a document from a first format to a second format according to claim 7, wherein the modifying the extracted data structure further comprises adding labels to the extracted data structure.

9. The method for converting a document from a first format to a second format according to claim 8, wherein the modifying the extracted data structure further comprises removing a portion of the extracted data structure.

10. The method for converting a document from a first format to a second format according to claim 8, wherein the modifying the extracted data structure further comprises removing a portion of the extracted data structure from a first location within the extracted data structure and adding the portion of the extracted data structure at a second location within the extracted data structure.

11. The method of converting a document from a first format to a second format according to claim 7, wherein the document comprises an HTML document, an XML document, or a PDF document.

12. A method for converting a document from a first format to a second format, the method comprising:
extracting a structure of a first document to form a first data structure;
modifying the first data structure to form a second data structure;
extracting content of a second document;
inserting the content of the second document into the second data structure, the content of the second document being different from content of the first document.

13. The method for converting a document from a first format to a second format according to claim 12, wherein the modifying the first data structure further comprises deleting a portion of the first data structure.

14. The method for converting a document from a first format to a second format according to claim 12, wherein the modifying the first data structure further comprises adding a label to a portion of the first data structure.

15. The method for converting a document from a first format to a second format according to claim 12, wherein the first and second documents are web pages.

16. A method for converting a document from a first format to a second format, the method comprising:
extracting a first data structure from a first document, content of the first document being stored in nodes of the data structure;
assigning a label to the nodes of the first data structure that store the content of the document based on the content stored in the nodes;
generating a one-dimensional list of the nodes that include the content of the document.

17. The method for converting a document from a first format to a second format according to claim 16,
providing a database including a second data structure associated with the first document, the second data structure specifying a manner of displaying at least one of the entries;
inserting entries of the list into the data structure to form an output file.

18. The method for converting a document from a first format to a second format according to claim 17, wherein the providing a database further comprises:
extracting a structure of a second document to form a second data structure, the second document having a same structure as the first document;
modifying the second data structure to form a third data structure;
storing the third data structure in a database.

19. The method for converting a document from a first format to a second format according to claim 18, wherein the modifying further comprises removing at least one portion of the second data structure.

20. The method for converting a document from a first format to a second format according to claim 18, wherein the modifying further comprises moving at least one portion of the second data structure from a first location within the second data structure to a second location within the data structure.

21. A computer readable medium comprising program instructions for:
dividing a document having a first structure into blocks;
creating a list having entries, individual entries of the list containing content of associated ones of the blocks;
providing a database including a data structure associated with the document, the data structure specifying a manner of displaying at least one of the entries;
inserting entries of the list into the data structure to form an output file.

22. A computer readable medium comprising program instructions for:
extracting a structure of a first document to form a first data structure;
modifying the first data structure to form a second data structure;
extracting content of a second document;
inserting the content of the second document into the second data structure, the content of the second document being different from content of the first document.

23. A computer readable medium comprising program instructions for:
extracting a first data structure from a first document, content of the first document being stored in nodes of the data structure;
assigning a label to the nodes of the first data structure that store the content of the document based on the content stored in the nodes;
generating a one-dimensional list of the nodes that include the content of the document.
